(19) United States
(12) Patent Application Publication
(10) Pub. No.: US 2025/0298148 A1
(43) Pub. Date: Sep. 25, 2025

(54) METHOD FOR RECEIVING RTK CORRECTION INFORMATION THROUGH HETEROGENEOUS NETWORKS

(71) Applicant: MUNHWA BROADCASTING CORP., Seoul (KR)

(72) Inventors: Seung Ho LEE, Seoul (KR); Dong Kwan LEE, Seoul (KR); Hong Gi SHIN, Seoul (KR); Doo Kyung PARK, Seoul (KR); Seung Yong LIM, Seoul (KR); Hyeong Joon KIM, Seoul (KR)

(73) Assignee: MUNHWA BROADCASTING CORP., Seoul (KR)

(21) Appl. No.: 18/786,999

(22) Filed: Jul. 29, 2024

(30) Foreign Application Priority Data
Mar. 19, 2024 (KR) 10-2024-0037705

(51) Int. Cl. G01S 19/25; G01S 19/43

(52) U.S. Cl. CPC G01S 19/25; G01S 19/43

(57) ABSTRACT

The present disclosure relates to a method for receiving RTK (Real-Time Kinematic) correction information using heterogeneous networks, especially the method enables RTK positioning in continuous and precise ways by receiving RTK correction information through another network, in the case that the validity of the RTK correction information received through a specific network is degraded or the RTK correction information cannot be received through the specific network.

### CROSS REFERENCE TO RELATED APPLICATION

This application claims priority to Korea Patent Application No. 10-2024-0037705 filed on Mar. 19, 2024, the content of which is expressly incorporated by reference in its entirety.

### TECHNICAL FIELD

The present disclosure relates to a method for receiving RTK (Real-Time Kinematic) correction information through heterogeneous networks, especially the method enables RTK positioning in continuous and precise ways by receiving RTK correction information through another network, in the cases that the validity of the RTK correction information received through a specific network is degraded or the RTK correction information cannot be received through the specific network.

### BACKGROUND

A Global Navigation Satellite System (GNSS) provides positioning information of an object and precise time information by using satellite navigation signals transmitted from multiple GNSS satellites.

Satellite navigation signals received from GNSS satellites contain various errors, which may result in positioning inaccuracies. This fact can pose safety risks in fields that require precise positioning, such as aviation and automotive industries.

Recently various positioning correction methods are being utilized to address these issues, and a real-time kinematic (RTK) positioning correction method is being utilized as a prominent example.

The RTK positioning correction method is one of the positioning correction methods that enables a rover to precisely perform real-time mobile positioning by receiving the RTK correction information provided from a base station (i.e., a reference station).

To provide the above RTK correction information to the rover, a network is essentially needed to transmit the information. Currently, RTK correction information is provided through only a single network, such as a communication network or a broadcast network, etc.

However, when providing RTK correction information through only a single network, there are issues such as the degradation of the validity of received RTK correction information over the single network or the inability to receive RTK correction information in the shadow areas of the single network. These issues result in reduced positioning accuracy or in misconducting real-time positioning.

Accordingly, the present disclosure proposes methods for providing RTK correction information efficiently through heterogeneous networks.

Furthermore, the present disclosure proposes a method of performing positioning by receiving RTK correction information through a broadcast network at a specific frequency, and enabling positioning by receiving RTK correction information through a communication network or a broadcast network at a different frequency, in cases that the validity of the received RTK correction information is compromised or it is impossible to receive RTK correction information through the broadcast network at the specific frequency.

Hereinafter, the prior arts existing in the technical field of the present disclosure are briefly described, and then descriptions of the technical aspects that the present disclosure seeks to achieve compared to the prior arts are followed.

First, KR 10-2622584 B1 (Jan. 8, 2024) relates to a device and method for correcting a position of a vehicle, in which the device is configured to receive RTK information and GPS information from an RTK system and GPS satellites respectively, and output the corrected position of the vehicle.

The KR 10-2622584 B1 only discloses the performing of positioning for a vehicle by receiving RTK information (i.e., RTK correction information) from the RTK system, and does not provide any description regarding the method how to receive the RTK correction information.

On the other hand, the present disclosure proposes a method for receiving RTK correction information through heterogeneous networks, wherein RTK correction information is received through relatively less expensive broadcast networks, and if the validity of RTK correction information is not guaranteed or if RTK correction information is not received, RTK correction information is obtained through a communication network, and once the frequency capable of receiving RTK correction information over a broadcast network is detected, then the reception of RTK correction information is achieved through the corresponding frequency of the broadcast network, thereby efficiently receiving the RTK correction information, whereas KR 10-2622584 does not mention, imply or suggest any of the technical features of the present disclosure.

Furthermore, KR 10-2146890 B1 (Aug. 21, 2020) pertains to a method for transmitting GPS correction information and a system for the same, in which GPS correction information is broadcasted via a mobile communication network or provided by unicasting to user terminals.

In other words, KR 10-2146890 B1 provides correction information for positioning through a communication network. In case of communication networks, there are issues with high costs and lack of service coverage in mountainous or suburban areas, resulting in the inability to perform real-time positioning in these areas.

However, the present disclosure receives RTK correction information through relatively less expensive broadcast networks. Wherein if the validity of RTK correction information is not guaranteed or if RTK correction information is not received, RTK correction information is received through a communication network or a broadcast network at a different frequency as an alternative network. When receiving RTK correction information through a communication network as an alternative network, upon detecting a broadcast frequency capable of receiving RTK correction information, RTK correction information is received through the broadcast network operating at the corresponding broadcast frequency. Whereas KR 10-2146890 B1 does not mention, imply or suggest any of the technical features of the present disclosure.

### BRIEF SUMMARY OF THE EMBODIMENTS

The present disclosure is devised to resolve the issues mentioned in the above, it is an objective of the present disclosure to provide a method for receiving RTK correction information by utilizing heterogeneous networks, enabling real-time mobile positioning by efficiently receiving RTK correction information through heterogeneous networks.

Additionally, it is another objective of the present disclosure is to provide a method for receiving RTK correction information through a specific broadcast network, receiving RTK correction information through a communication network, a broadcast network at another frequency, or a combination thereof respectively in background, identifying alternative network by checking validity for each of the networks, and continuously receiving RTK correction information through the identified alternative network, when the validity of RTK correction information received through the specific broadcast network is low or RTK correction information is not received through the specific broadcast network.

Additionally, it is another objective of the present disclosure to provide a method for including a broadcast network at another frequency among the identified alternative networks, and receiving RTK correction information through the broadcast network at another frequency, if the validity of RTK correction information received through a specific broadcast network is degraded or if RTK correction information is not received through the specific broadcast network.

Additionally, it is another objective of the present disclosure to provide a method for including only a communication network among the identified alternative networks, receiving RTK correction information through the communication network, if the validity of the RTK correction information received through a specific broadcast network is low or if the RTK correction information is not received through the specific broadcast network, and receiving RTK correction information through the broadcast network at a corresponding broadcast frequency, if a broadcasting signal including the RTK correction information is received properly at the corresponding broadcast frequency.

1 According to one embodiment of the present disclosure, it is characterized in that a method for receiving RTK correction information in a device for receiving the RTK correction information through heterogeneous networks, the method comprises: receiving RTK correction information in a first foreground through a broadcast network at a specific frequency in a first broadcast reception module; if the RTK correction information received in the first foreground is predicted to be invalid within a predetermined cycle, receiving RTK correction information in a first background through a communication network in a communication module; and if the RTK correction information received in the first foreground is determined to be invalid, switching a reception mode of the first broadcast reception module to background and a reception mode of the communication module to foreground.

2 Furthermore, it is characterized in that the method further comprises: if an alternative frequency capable of receiving the RTK correction information is explored in the first broadcast reception module and the alternative frequency is determined to be valid, blocking the communication module from receiving the RTK correction information, switching the reception mode of the first broadcast reception module to foreground, and switching the reception mode of the communication module to background.

3 Furthermore, it is characterized in that wherein an error rate of the received RTK correction information is calculated, then if the error rate continuously increases during a predetermined cycle, the error rate is predicted to exceed a predetermined threshold within the predetermined cycle based on an increasing rate of the error rate, and the error rate exceeds the predetermined threshold, then the received RTK correction information is determined to be invalid.

4 Furthermore, it is characterized in that the method further comprises: exploring an alternative frequency capable of receiving RTK correction information from a broadcast frequency list in the first broadcast reception module; receiving RTK correction information in second background through the broadcast network at the alternative frequency explored in the first broadcast reception module; and if the RTK correction information received in the second background through the alternative frequency of the broadcast network by the first broadcast reception module is determined to be valid, blocking the reception of RTK correction information of the communication module, switching the reception mode of the communication module to background and switching the reception mode of the first broadcast reception module to foreground, wherein the alternative frequency is stored and managed in the broadcast frequency list according to each of regions and periodically updated through the broadcast network.

5 Additionally, it is characterized in that the method further comprises: if the RTK correction information is not received in the first foreground, switching the reception mode of the communication module to foreground and switching the reception mode of the first broadcast reception module to background; exploring an alternative frequency capable of receiving RTK correction information from the broadcast frequency list in the first broadcast reception module; receiving RTK correction information in third background through the broadcast network at the alternative frequency explored in the first broadcast reception module; and if the RTK correction information received in the third background is determined to be valid, switching the reception mode of the first broadcast reception module to foreground, blocking the reception of RTK correction information through the communication module, and switching the reception mode of the communication module to background.

6 Furthermore, it is characterized in that the method further comprises: if the RTK correction information received in the first foreground is predicted to be invalid within predetermined cycle, exploring of an alternative frequency capable of receiving RTK correction information by referring to a broadcast frequency list in the second broadcast reception module; receiving the RTK correction information in fourth background through the broadcast network at the alternative frequency explored in the second broadcast reception module; and if the RTK correction information received in the first foreground is invalid, switching the reception mode of the second broadcast reception module or the communication module to foreground, and switching the reception mode of the first broadcast reception module to background, depending on validity of the RTK correction information received in the first background and the fourth background respectively.

7 Furthermore, it is characterized in that the method further comprises: if the RTK correction information received both in the first background and the fourth background respectively is valid, blocking the reception of RTK correction information through the communication module, switching the reception mode of the second broadcast reception module to foreground, blocking the RTK correction information reception through the first broadcast reception module, and switching the reception mode of the first broadcast reception module to the background,

8 Furthermore, it is characterized in that the method further comprises: if the RTK correction information received in the first background is valid and the RTK correction information received in the fourth background is invalid, switching the reception mode of the communication module to foreground, blocking the RTK correction information reception from the first broadcast reception module and the second broadcast reception module, and switching the reception mode of the first broadcast reception module to background; and if an alternative frequency capable of receiving RTK correction information is explored in the first broadcast reception module or the second broadcast reception module, and the alternative frequency is determined to be valid, blocking the RTK correction information reception for the communication module, switching the reception mode of the communication module to background, and switching the reception mode of the first broadcast reception module or the second broadcast reception module having explored the alternative frequency to foreground.

9 Furthermore, it is characterized in that the method further comprises: if the RTK correction information is not received in the first foreground, switching the reception mode of the communication module to foreground, and switching the reception mode of the first broadcast reception module to background; and if an alternative frequency capable of receiving RTK correction information in the first broadcast reception module or the second broadcast reception module is explored and the alternative frequency is determined to be valid, blocking the reception of the RTK correction information from the communication module, switching the reception mode of the communication module to background, and switching the reception mode of the first broadcast reception module or the second broadcast reception module having explored the alternative frequency to foreground.

Moreover, it is characterized in that a device for receiving the RTK correction information through heterogeneous networks, the device comprises: a memory configured to store a program code implementing the RTK correction information reception methods through the heterogeneous networks; and a processor configured to load the program code stored in the memory and execute the program code.

A method for receiving RTK correction information through heterogeneous networks in accordance with the present disclosure, configured as described above, can effectively perform real-time positioning by enabling continuous reception of RTK correction information through another network, even when the RTK correction information receiving through a specific network is invalid or the reception of the RTK correction information through the specific network is impossible.

### BRIEF DESCRIPTION OF THE DRAWINGS

FIG. 1 is a diagram for explaining a method for receiving the RTK correction information through heterogeneous networks according to one embodiment of the present disclosure.

FIG. 2 is a diagram illustrating the method for receiving the RTK correction information through heterogeneous networks according to one embodiment of the present disclosure.

FIG. 3 is a diagram illustrating the method for receiving the RTK correction information through heterogeneous networks according to another embodiment of the present disclosure.

FIG. 4 is a diagram illustrating the method for receiving the RTK correction information through heterogeneous networks according to another embodiment of the present disclosure.

FIG. 5 is a diagram for explaining a method for receiving RTK correction information in background according to one embodiment of the present disclosure.

FIG. 6 is a block diagram illustrating the configuration of a device for receiving an RTK correction information through heterogeneous networks according to one embodiment of the present disclosure.

FIG. 7 is a flowchart illustrating a process of receiving RTK correction information through heterogeneous networks according to one embodiment of the present disclosure.

FIG. 8 is a flowchart illustrating the process of receiving RTK correction information through heterogeneous networks according to another embodiment of the present disclosure.

FIG. 9 is a flowchart illustrating the process of receiving RTK correction information through heterogeneous networks according to another embodiment of the present disclosure.

FIG. 10 is a flowchart illustrating the process of receiving RTK correction information through heterogeneous networks according to another embodiment of the present disclosure.

### DETAILED DESCRIPTION OF THE EXEMPLARY EMBODIMENTS

Hereinafter, various embodiments of the present disclosure will be described in detail with reference to the accompanying drawings. The same reference numerals shown in each drawing indicate the same members. In addition, specific structural or functional descriptions of the embodiments of the present disclosure are exemplified only for the purpose of describing the embodiments according to the present disclosure, and unless defined otherwise, all terms used herein, comprising technical or scientific terms, have the same meaning as commonly understood by those skilled in the art to which the present disclosure belongs. Terms such as those defined in a commonly used dictionary should be interpreted as having a meaning consistent with the meaning in the context of the related art, and should not be interpreted as an ideal or excessively formal meaning unless explicitly defined in the present specification. The reference numerals are described as follows: 10: a reference station, 20: a RTK correction information providing device, 30: a rover, 100: a RTK correction information receiving device, 110: a first broadcast reception module, 120: a second broadcast reception module, 130: a communication module, 140: an error rate calculation module, 150: a validity prediction module, 160: a switching module, and 170: a positioning module.

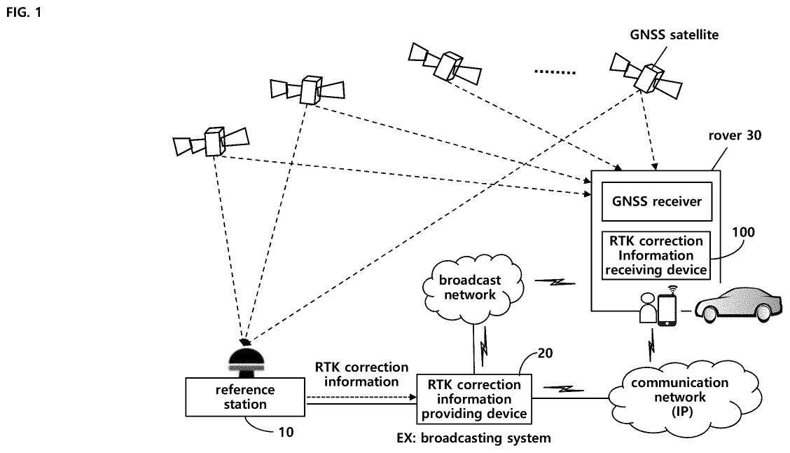

FIG. 1 is a diagram for explaining a method for receiving the RTK correction information through heterogeneous networks according to one embodiment of the present disclosure.

As shown in FIG. 1, a device for receiving RTK correction information through heterogeneous networks 100 (hereinafter referred to as an RTK correction information receiving device) according to an embodiment of the present disclosure is configured to be mounted on a rover 30, receive RTK correction information in real-time from an RTK correction information providing device 20, and be used for positioning of the rover 30.

The RTK correction information providing device 20 is configured to receive RTK correction information from a reference station 10 and transmit the RTK correction information through a communication network and a broadcast network. The RTK correction information providing device 20 may be provided at a broadcasting system that transmits broadcast contents through a broadcast network, a communication network, or a combination thereof.

The reference station 10 is configured to have a pre-measured precise location, receive satellite navigation signals from multiple GNSS satellites, measure the location of the reference station 10, generate RTK correction information for correcting the position of the rover 30 through the measured location and the pre-measured precise location, and then transmit the generated RTK correction information to the RTK correction information providing device 20.

The GNSS satellites may include various navigation satellites, such as GPS (Global Positioning System) satellites from the United States, Galileo satellites from Europe, GLONASS (Global Navigation Satellite System) satellites from Russia, and Beidou satellites from China.

The reference station 10 is configured to generate RTK correction information by comparing the location of the reference station measured through satellite navigation signals receiving from more than four identical GNSS satellites with the pre-measured precise location of the reference station 10 and transmit the generated RTK correction information to the RTK correction information providing device 20.

The reference station 10 is configured to provide RTK correction information to the RTK correction information providing device 20 at a predetermined cycle (e.g., once at every 1 second). That is, the RTK correction information providing device 20 is also configured to broadcast RTK correction information at a predetermined cycle (e.g., once at every 1 second).

The rover 30 is configured to comprise a GNSS receiver and an RTK correction information receiving device 100. The GNSS receiver is configured to measure the position of the rover 30 by using satellite navigation signals received from multiple GNSS satellites.

Additionally, the RTK correction information receiving device 100 periodically is configured to receive RTK correction information through a broadcast network or a communication network, and measure the precise position of the rover 30 that removes errors by applying the received RTK correction information to the position of the rover 30 measured in the GNSS receiver. Thus, the RTK correction information receiving device 100 and the GNSS receiver can be comprised into an integrated device.

On the one hand, the broadcast network may take advantage of having low cost by virtue of allowing multiple users to connect simultaneously over wide areas with high power. However, they may take disadvantage of having many shadow areas due to being greatly influenced by terrain and infrastructure.

Additionally, the communication network take advantage of having a stable reception environment by providing services through numerous base stations in densely populated urban areas. However, they may take disadvantage of being expensive and having shadow areas in mountainous or remote areas with fewer inhabitants.

Therefore, the RTK correction information receiving device 100 is configured to receive RTK correction information through the broadcast network, but if the RTK correction information received through the broadcast network is determined to be invalid or if the RTK correction information cannot be received, the RTK correction information receiving device 100 is further configured to receive RTK correction information through a broadcast network at another frequency. At this time, if the RTK correction information received through the broadcast network at the another frequency is also determined to be invalid, or if another broadcast frequency is not detected, the RTK correction information receiving device 100 is configured to receive RTK correction information through a communication network so that it enables real-time positioning of the rover 30.

Wherein, when receiving RTK correction information through the communication network, if a broadcast frequency capable of receiving RTK correction information is detected, the RTK correction information is received through the broadcast network at the detected frequency, then if the received RTK correction information is determined to be valid, the connection to the communication network is blocked, and the RTK correction information is received through the broadcast network so that it can be used positioning of the rover 30.

Wherein, the communication network basically refers to an IP-based wireless communication network for data transmission and reception.

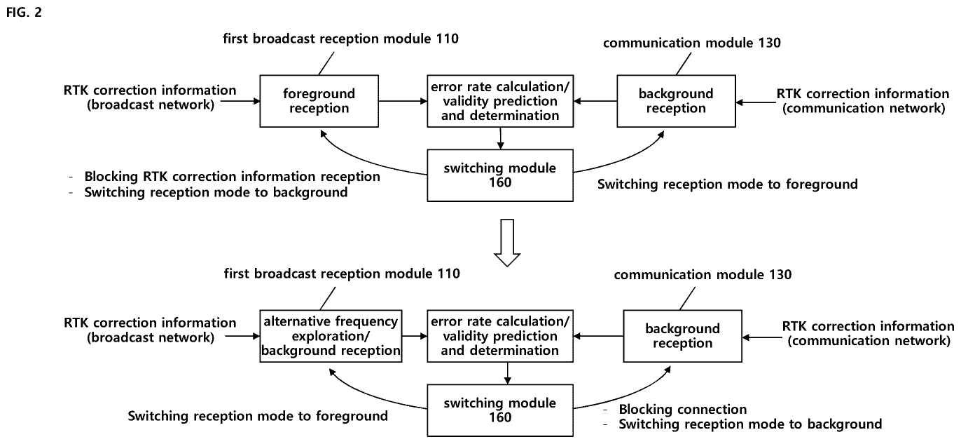

The process of receiving RTK correction information in the RTK correction information receiving device 100 is explained in detail with reference to FIG. 2 to FIG. 4.

FIG. 2 is a diagram illustrating the method for receiving the RTK correction information through heterogeneous networks according to one embodiment of the present disclosure.

That is, FIG. 2 illustrates a method for receiving RTK correction information when the RTK correction information receiving device 100 is configured with one broadcast reception module (i.e., broadcast tuner) capable of receiving a single broadcast signal.

As shown in FIG. 2, a first broadcast reception module 110 of the RTK correction information receiving device 100 according to an embodiment of the present disclosure is configured to receive RTK correction information in foreground through a specific frequency of a broadcast network.

When the RTK correction information receiving device 100 is turned on, the first broadcast reception module 110 is configured to periodically (e.g., once at every 1 second) receive RTK correction information through the broadcast network associated with the frequency corresponding to the best quality broadcast signal for receiving RTK correction information among the frequencies on the broadcast frequency list.

The broadcast frequency list is comprised of frequencies (i.e., broadcast frequencies) and reception information, which are capable of receiving RTK correction information by each of regions. The reception information, which is for receiving RTK correction information from the broadcast signal, is comprised of PLP (physical layer pipe), service ID, reception IP, and so on.

The broadcast frequency list can be pre-stored and managed, or can be periodically updated and managed through a broadcast network. Moreover, the update can also be done through a communication network.

The first broadcast reception module 110 is configured to receive RTK correction information through the broadcast network associated with the frequency corresponding to the strongest received signal strength indicator (RSSI, received signal strength indicator), by detecting, scanning or searching frequencies available for receiving RTK correction information through the broadcast frequency list.

In addition, the RTK correction information receiving device 100 is configured to calculate an error rate of the RTK correction information received through the first broadcast reception module 110.

Additionally, if the error rates calculated over multiple cycles continuously increase over multiple cycles, the validity of the RTK correction information which is received in foreground within a predetermined cycle is predicted based on the increasing rate of the error rates. Wherein, if it is predicted that the RTK correction information will not be valid within a predetermined cycle, the communication module 130 of the RTK correction information receiving device 100 is configured to receive the RTK correction information in background through a communication network.

That is, if the error rate of the received RTK correction information is calculated and the calculated error rate continuously increases over a predetermined cycle, the validity is predicted by whether the increasing rate of the error rate exceeds a predetermined threshold within a predetermined cycle.

Therefore, if it is predicted that the RTK correction information received in foreground through the first broadcast reception module 110 will be invalid, the RTK correction information receiving device 100 is configured to instruct the communication module 130 to receive the RTK correction information in background through the communication network.

Meanwhile, if the calculated error rate exceeds a predetermined threshold, the RTK correction information receiving device 100 is configured to determine that the received RTK correction information is invalid, whereas if it is below the predetermined threshold, it is determined as the received RTK correction information is valid.

The error rate can be calculated through various methods such as CRC (cyclic redundancy check), parity bit, FEC (forward error correction), Hamming function, and so on. The detailed explanations of the CRC, parity bit, FEC, Hamming function, or their combinations, which are mainly used to detect errors in communication, are omitted.

Additionally, if it is invalid as a result of determining the validity of the RTK correction information received in foreground through the first broadcast reception module 110, the switching module 160 of the RTK correction information receiving device 100 is configured to block the reception of RTK correction information through the first broadcast reception module 110, switch the reception mode of the first broadcast reception module 110 to background, switch the reception mode of the communication module 130 to foreground, and then enable the communication module 130 to receive the RTK correction information in foreground.

Wherein, the switching module 160 is configured to perform the switching if it is determined that the RTK correction information received in background through the communication module 130 is valid based on its error rate and the validity decided by the error rate.

Furthermore, when the reception mode is switched to background, the first broadcast reception module 110 searches (i.e., explores) for an alternate frequency corresponding to the best quality of a broadcast signal capable of receiving RTK correction information by referring to the broadcast frequency list.

When the alternative frequency is explored, the first broadcast reception module 110 receives RTK correction information in background through the communication network at the identified alternate frequency, and the RTK correction information receiving device 100 evaluates the validity of the RTK correction information received in background. Of course, since the corresponding RTK correction information is received through the broadcast network at the alternate frequency corresponding to the best quality of broadcast signal, it is obvious that the signal strength may be high, the error rate may be low, and the validity is assured.

Then, the switching module 160 is configured to block (block connection/access) the communication module 130 to receive the RTK correction information, switch the reception mode to background, and switch the reception mode of the first broadcast reception module 110 to foreground, and thus receive RTK correction information in foreground through the alternate frequency of the broadcast network.

In other words, the RTK correction information receiving device 100 is configured to receive RTK correction information through a relatively less expensive broadcast network, and if the validity of the RTK correction information received from the broadcast network is determined to be invalid, the RTK correction information receiving device 100 is configured to receive the RTK correction information through the communication network. Even in this case, when an alternative frequency that can receive valid RTK correction information is detected, the RTK correction information receiving device 100 is configured to block the connection to the communication network and immediately receive the RTK correction information through the broadcast network at the corresponding alternative frequency, and thus minimize the use of relatively expensive communication networks and maximize the use of relatively less expensive broadcast networks, thereby efficiently receiving RTK correction information.

Meanwhile, when performing the positioning of the rover 300, the RTK correction information receiving device 100 is configured to utilize the RTK correction information received in foreground and the position information measured by the GNSS receiver equipped on the rover 300.

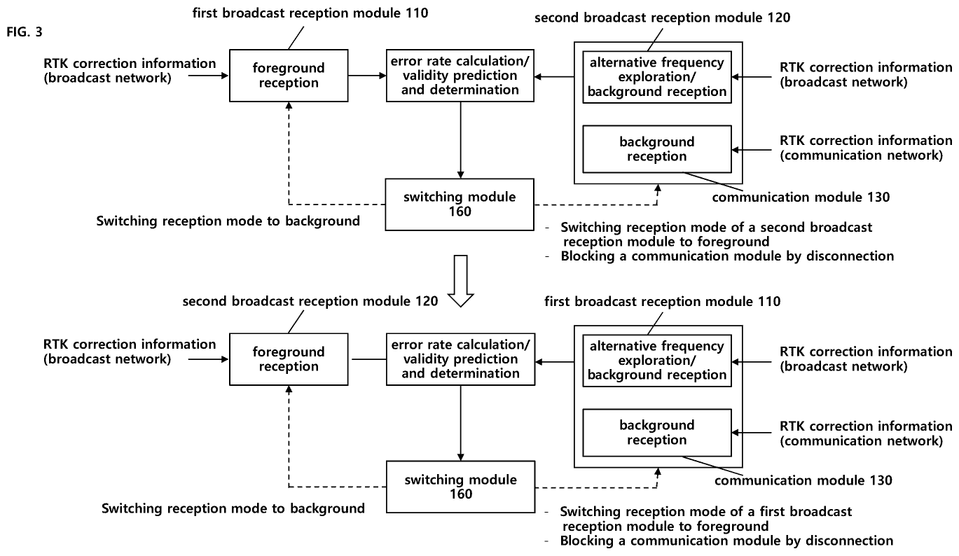

FIG. 3 is a diagram illustrating the method for receiving the RTK correction information through heterogeneous networks according to another embodiment of the present disclosure.

More specifically, FIG. 3 illustrates a method for receiving RTK correction information when the RTK correction information receiving device 100 is configured with two or more broadcast reception modules (broadcast tuners) capable of simultaneously receiving two or more broadcast signals.

As shown in FIG. 3, the first broadcast reception module 110 of the RTK correction information receiving device 100 according to an embodiment of the present disclosure is configured to periodically receive RTK correction information in foreground through a specific frequency of the broadcast network. Of course, it is also possible to receive RTK correction information in foreground through the second broadcast reception module 120.

Furthermore, the RTK correction information receiving device 100 is configured to calculate the error rate of the RTK correction information received in foreground through the first broadcast reception module 110.

Wherein, the RTK correction information receiving device 100 is configured to calculate an error rate for he RTK correction information received in foreground through the first broadcast reception module 110 over predetermined cycle, and if the error rates continuously increase over multiple cycles, then predict the validity of the RTK correction information received in foreground through the first broadcast reception module 110 within predetermined cycle based on the increasing rate of the error rate.

Additionally, if it is predicted to be invalid, as the result of the validity prediction, the second broadcast reception module 120 is configured to explore an alternative frequency by referring to the broadcast frequency list, and then it receives the RTK correction information in background through the explored alternative frequency of the broadcast network. And the communication module 130 is also configured to receive the RTK correction information in background through the communication network by using connection information.

Wherein, if the second broadcast reception module 120 explores the alternative frequency, the RTK correction information receiving device 100 is configured to block the reception of RTK correction information in background through the communication module 130. It is to minimize the use of relatively expensive communication networks.

Then, if it is determined that the RTK correction information received through the first broadcast reception module 110 in foreground is invalid, the switching module 160 is configured to block the reception of RTK correction information through the first broadcast reception module 110 and switch its reception mode to background. Additionally, the switching module 160 is configured to switch the reception mode of the second broadcast reception module 120 to receive RTK correction information in foreground. The RTK correction information receiving device 100 is also configured to block (i.e., disconnects to the communication network) the reception (background reception) of RTK correction information through the communication module 130.

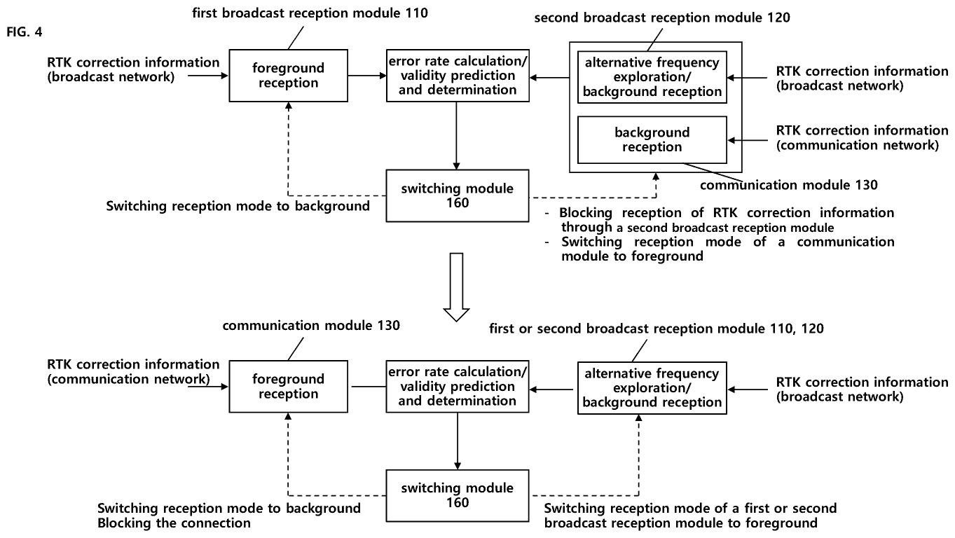

Meanwhile, if the second broadcast reception module 120 fails to find alternative frequency or it is determined that the RTK correction information received in background is invalid, the RTK correction information receiving device 100 can also be configured to receive RTK correction information in background by the communication module 130 through the communication network, and further details will be provided by referring to FIG. 4.

FIG. 4 is a diagram illustrating the method for receiving the RTK correction information through heterogeneous networks according to another embodiment of the present disclosure.

More specifically, FIG. 4 shows an example of receiving and switching RTK correction information in background through a communication network, shown in FIG. 3.

As shown in FIG. 4, in the case that it is predicted that it will be invalid within predetermined cycle in the middle of receiving RTK correction information in foreground through the first broadcast reception module 110, the RTK correction information receiving device 100 in accordance with one embodiment of the present disclosure is configured to receive RTK correction information in background through the second broadcast reception module 120 and the communication module 130.

Wherein, if it is determined that the RTK correction information received in foreground through the first broadcast reception module 110 is invalid, and the second broadcast reception module 120 fails to search for an alternative frequency or the RTK correction information received in background is invalid, then the RTK correction information receiving device 100 is configured to block the reception of RTK correction information through the first and second broadcast reception modules, subsequently switch the reception mode of the first broadcast reception module 110 to background, and switch the reception mode of the communication module 130 to foreground. Thus, the communication module 130 receives the RTK correction information in foreground.

Furthermore, the first broadcast reception module 110 or the second broadcast reception module 120 switched to background is configured to explore an alternative frequency capable of receiving RTK correction information through the broadcast frequency list. Moreover, the RTK correction information receiving device 100 determines the validity for the RTK correction information received in background through the alternative frequency of the broadcast network. Subsequently, if the RTK correction information received from the first broadcast reception module 110 or the second broadcast reception module 120 is valid, the switching module 160 is configured to switch the reception mode of the specific broadcasting reception module exploring the alternative frequency to foreground, and block (i.e., disconnect) the reception of RTK correction information by the communication module 130 and switch the reception mode to background.

As described with reference to FIG. 2 to FIG. 4, the switching to foreground and background enables the error rate of the RTK correction information received in foreground to be calculated, the validity to be predicted, and real-time positioning iteratively to be performed based on the validity with highly reliable RTK correction information.

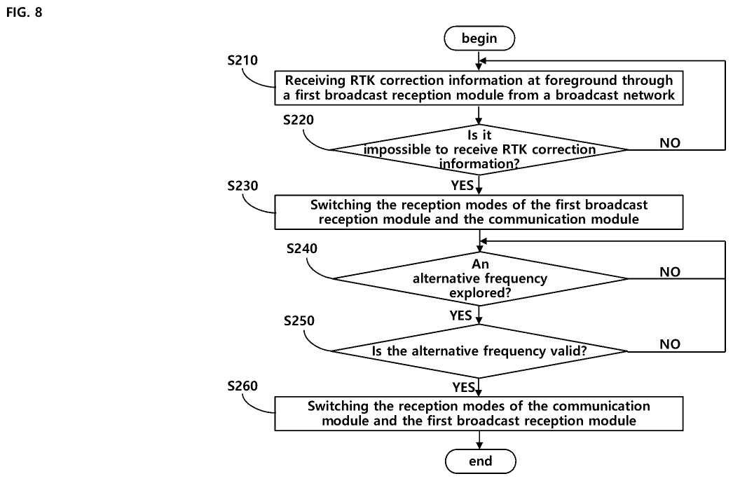

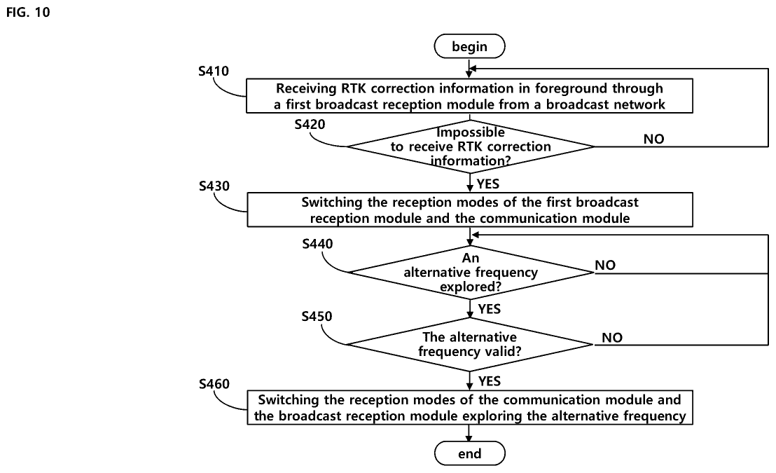

Furthermore, FIG. 2 to FIG. 4 describe the switching of the reception mode for RTK correction information through each network, in the case that it is predicted that the RTK correction information will be invalid within a predetermined cycle. However, while receiving the RTK correction information in foreground, the switching is also necessary in the case that it becomes impossible to receive the RTK correction information due to shadow areas or similar issues. The switching is explained in detail with reference to FIG. 8 and FIG. 10.

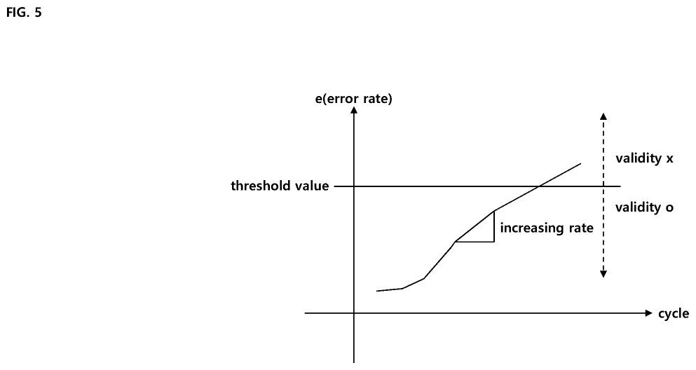

FIG. 5 is a diagram for explaining a method for receiving RTK correction information in background according to one embodiment of the present disclosure.

As shown in FIG. 5, the RTK correction information receiving device 100 according to an embodiment of the present disclosure is configured to calculate an error rate of the RTK correction information received in foreground.

The RTK correction information receiving device 100 is configured to calculate the increasing rate (rate of increment for the error rate) that the error rate of the RTK correction information received in foreground is increased continuously over predetermined cycle.

The increasing rate is calculated by dividing the amount of change in error rate for predetermined cycle by the time for the predetermined cycle.

Wherein, if the error rate is predicted to exceed a predetermined threshold within predetermined cycle based on the increasing rate of the error rate, it is anticipated that the RTK correction information will not be valid within the predetermined cycle, and then the RTK correction information reception device 100 is configured to receive the RTK correction information in background through another network.

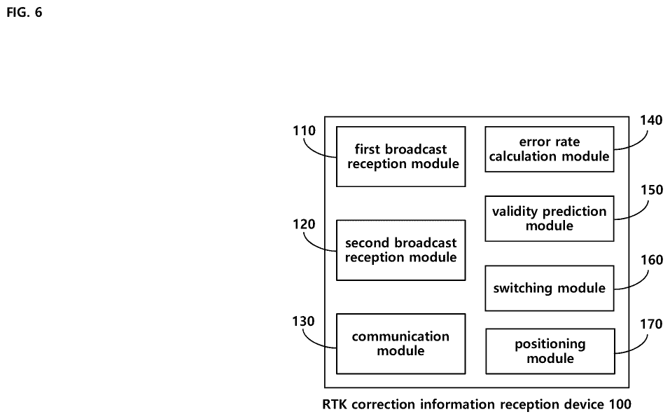

FIG. 6 is a block diagram illustrating the configuration of a device for receiving an RTK correction information through heterogeneous networks according to one embodiment of the present disclosure.

As shown in FIG. 6, the RTK correction information reception device 100 according to an embodiment of the present disclosure is configured to comprise a first broadcast reception module 110, a second broadcast reception module 120, a communication module 130, an error rate calculation module 140, a validity prediction module 150, a switching module 160, and a positioning module 170.

The first broadcast reception module 110 and the second broadcast reception module 120 are configured to receive RTK correction information through a broadcast network in either foreground or background, depending on the reception mode. As previously described, the broadcast reception modules can be configured with a single module or two separate modules.

The communication module 130 is configured to receive RTK correction information through a communication network in either foreground or background, depending on the reception mode.

Detailed descriptions on receiving RTK correction information in either foreground or background are provided with reference to FIG. 2 to FIG. 4, so they will be omitted herein.

The error rate calculation module 140 is configured to calculate the error rate of the RTK correction information being received in foreground, background, or their combinations thereof.

The validity prediction module 150 is configured to predict the validity of the RTK correction information received in foreground within predetermined cycle by calculating the increasing rate of the error rate. The prediction of validity is described in detail in FIG. 2 to FIG. 4, so it is omitted herein.

The switching module 160 is configured to switch the reception mode of the first broadcast reception module 110, the second broadcast reception module 120, or the communication module 130 to foreground or background, based on the predicted validity. The switching is described in detail with reference to FIG. 2 to FIG. 4, so it will be omitted herein.

The positioning module 170 is configured to perform the positioning by applying the RTK correction information received in foreground to the positional information measured by the GNSS receiver, and also perform outputting the positioning result.

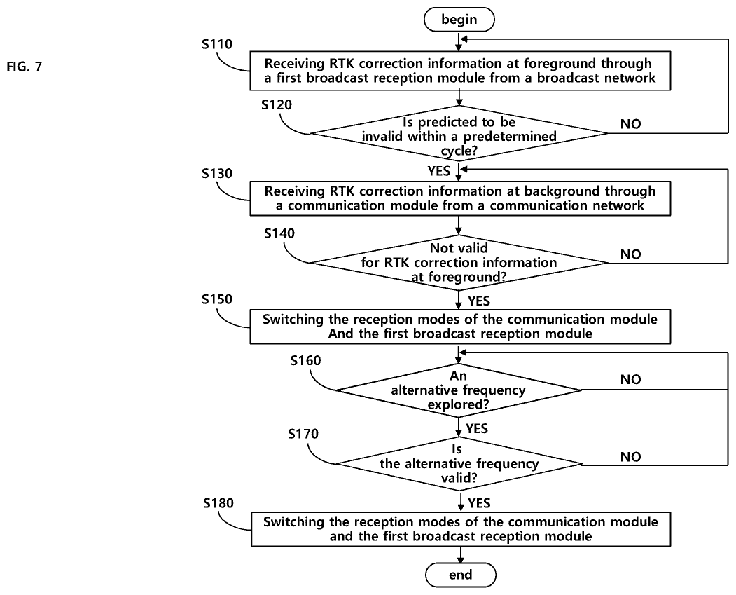

FIG. 7 is a flowchart illustrating a process of receiving RTK correction information through heterogeneous networks according to one embodiment of the present disclosure.

FIG. 7 illustrates the procedure for receiving RTK correction information in the case that the broadcast reception module and the communication module are combined into a single module. Firstly, the RTK correction information receiving device 100 is configured to receive RTK correction information in first foreground through a specific frequency of a broadcast network by the first broadcast reception module 110, as shown in S110.

If the RTK correction information received in the first foreground is predicted to be invalid within predetermined cycle, as shown in S120, the RTK correction information receiving device 100 is configured to receive RTK correction information in first background through a communication module 130 by using the connection information of the communication module 130, as shown in S130.

To do this, the RTK correction information receiving device 100 is configured to comprise calculating an error rate, where an error rate of the RTK correction information received in the first foreground is calculated by the error rate calculation module 140, and predicting a validity, where the validity of the RTK correction information received in foreground within predetermined cycle is predicted by using the calculated error rate through the the validity prediction module 150. The calculation of the error rate and the prediction of validity are described in detail with reference to FIG. 2 to FIG. 5, so they are omitted herein.

Subsequently, if the RTK correction information received in the first foreground is determined to be invalid, as shown in S140, the RTK correction information receiving device 100 is configured to mutually switch the reception modes of the communication module 130 and the first broadcast reception module 110 through the switching module 160, as shown in S150.

In other words, the switching of S150, comprises blocking the reception of RTK correction information from the first broadcast reception module 110, switching the reception mode to background, and switching the reception mode of the communication module 130 to foreground.

Then, the first broadcast reception module 110 is configured to explore an alternative frequency, where alternative frequency capable of receiving RTK correction information is explored by using the broadcast frequency list.

Wherein, if an alternative frequency is explored, as shown in S160, the first broadcast reception module 110 is configured to receive RTK correction information through the alternative frequency of the broadcast network in second background.

Furthermore, the RTK correction information receiving device 100 is configured to assess the validity of the RTK correction information received in the second background, if the RTK correction information is valid, as shown in S170, block the reception of RTK correction information for the communication module 130, switch the reception mode to background, and switch the reception mode of the first broadcast reception module 100 to foreground, as shown in S180.

Meanwhile, the RTK correction information receiving device 100 further includes a positioning performed by the positioning module 170, which conducts positioning for the rover 300 by utilizing the RTK correction information received in foreground.

FIG. 8 is a flowchart illustrating the process of receiving RTK correction information through heterogeneous networks according to another embodiment of the present disclosure.

FIG. 8 illustrates a procedure for receiving RTK correction information in the case that the reception of the RTK correction information becomes impossible through the broadcast network, in the embodiment described of FIG. 7. As illustrated in FIG. 8, the RTK correction information receiving device 100 is configured to receive the RTK correction information through a specific frequency of a broadcast network in first foreground through the first broadcast reception module 110, as shown in S210. The first foreground is identical to the first foreground shown in FIG. 7.

If the reception of RTK correction information is impossible in the first foreground, as shown in S220, the RTK correction information receiving device 100 is configured to switch the reception mode of the first broadcast reception module 110 to background and switch the reception mode of the communication module 130 to foreground through the switching module 160, as shown in S230.

Wherein, the communication module 130 is configured to receive the RTK correction information in foreground through the broadcast network.

Then, the RTK correction information receiving device 100 is configured to explore an alternative frequency by using the broadcast frequency list through the first broadcast reception module 110, as shown in S240.

Wherein, the RTK correction information receiving device 100 is configured to receive the RTK correction information in third background through the broadcast network at the alternative frequency explored by the first broadcast reception module 110

If the RTK correction information received in the third background is determined to be valid, as shown in S250, the switching module 160 is configured to block the reception of RTK correction information from the communication module 130, switch the reception mode of the communication module 130 to background, and switch the reception mode of the first broadcast reception module 110 to foreground, as shown in S260.

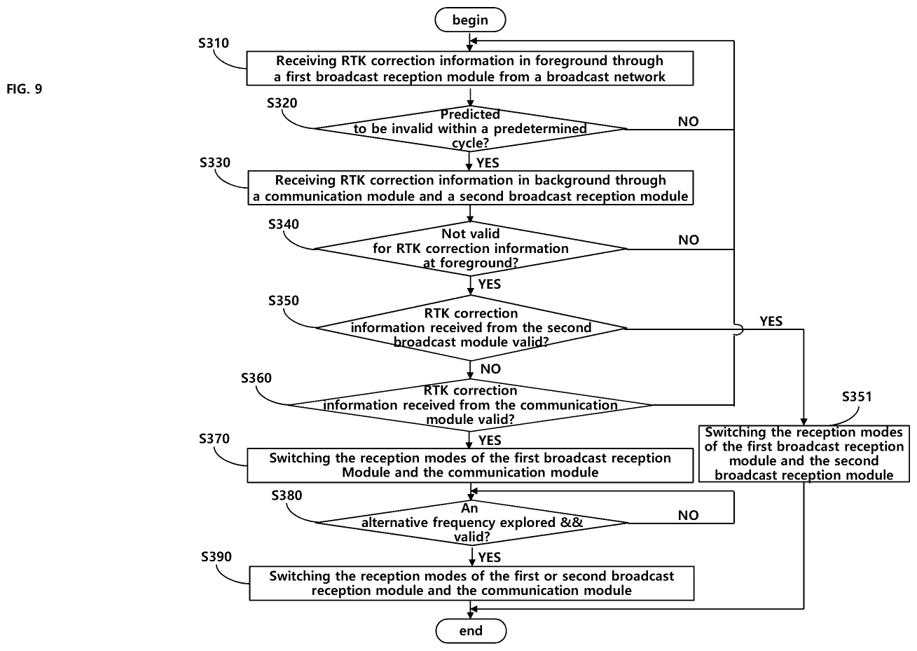

FIG. 9 is a flowchart illustrating the process of receiving RTK correction information through heterogeneous networks according to another embodiment of the present disclosure.

FIG. 9 shows a procedure for receiving RTK correction information in the case that there are two broadcast reception modules. As shown in FIG. 9, the first broadcast reception module 110 is configured to receive RTK correction information in first foreground through a specific frequency of a broadcast network, as shown in S310.

Subsequently, if it is predicted that the RTK correction information received in the first foreground will be invalid within a predetermined cycle, as shown in S320, the RTK correction information receiving device is configured to receive RTK correction information in first background through the communication module and receive RTK correction information in fourth background through the second broadcast reception module 120, as shown in S330.

Wherein, the RTK correction information receiving device 100 is configured to explore an alternative frequency capable of receiving RTK correction information by referring to the broadcast frequency list through the second broadcast reception module 120.

Thus, the RTK correction information receiving device 100 is configured to calculate an error rate of the RTK correction information received in the first foreground through the error rate calculation module 140 and predict the validity of the RTK correction information received in foreground within a predetermined cycle by using the calculated error rate calculated through the validity prediction module 150.

Subsequently, if the RTK correction information received in the first foreground is invalid, as shown in S340, and the RTK correction information received in the fourth background is valid, as shown in S350, the RTK correction information receiving device 100 is configured to switch the reception modes of the first broadcast reception module 110 and the second broadcast reception module 120 through the switching module 160, as shown in S351.

That is, the switching of S351 involves blocking the reception of RTK correction information for the first broadcast reception module 110, switching the reception mode of the first broadcast reception module 110 to background, and switching the reception mode of the second broadcast reception module 120 to foreground.

Meanwhile, if the RTK correction information received in the first foreground and the RTK correction information received in the fourth background are invalid, as shown in S340 and S350, but the RTK correction information received in the first background is valid, as shown in S360, the RTK correction information receiving device 100 is configured to switch the reception modes of the first broadcast reception module 110 and the communication module 130 through the switching module 160, as shown in S370.

The switching of S370 involves blocking the reception of RTK correction information for both the first broadcast reception module 110 and the second broadcast reception module 120, switching the reception mode of the first broadcast reception module 110 to background, and switching the reception mode of the communication module 130 to foreground.

Subsequently, if an alternative frequency is explored by either the first broadcast reception module 110 or the second broadcast reception module 120, and the RTK correction information received in background through the alternative frequency of a broadcast network is determined to be valid, as shown in S380, the RTK correction information receiving device 100 is configured to switch the reception modes of the first or second broadcast reception module that explored the alternative frequency and the communication module 130, as shown in S390.

That is, the switching of S390 involves exploring an alternative frequency, switching the reception mode of the first or second broadcast reception module, which successfully receives the valid RTK correction information, to foreground, and switching the reception mode of the communication module 130 to background.

FIG. 10 is a flowchart illustrating the process of receiving RTK correction information through heterogeneous networks according to another embodiment of the present disclosure.

FIG. 10 shows a procedure for receiving RTK correction information in the case that RTK correction information is not received through the broadcast network, as in the embodiment of FIG. 9. As specified in FIG. 10, the RTK correction information receiving device 100 is configured to receive RTK correction information in first foreground through a specific frequency of a broadcast network, as shown in S410. The first foreground described in FIG. 10 is equivalent to the first foreground described in FIG. 9.

Then, if the RTK correction information cannot be received through the first broadcast reception module 110, as shown in S420, the RTK correction information receiving device 100 is configured to switch the reception modes of the first broadcast reception module 110 and the communication module 130 through the switching module 160, as shown in S430.

Wherein, the communication module 130 is configured to receive RTK correction information in foreground through the broadcast network.

Then, the RTK correction information receiving device 100 is configured to explore an alternative frequency capable of receiving RTK correction information through the broadcast frequency list in either the first broadcast reception module 110 or the second broadcast reception module 120.

Wherein, if an alternative frequency is explored, as shown in S440, the RTK correction information receiving device 100 is configured to switch the reception modes of the communication module 130 and the first or second broadcast reception module that explores the alternative frequency, as shown in S450.

In other words, the RTK correction information receiving device 100 is configured to receive RTK correction information in fifth background through the first or second broadcast reception module that explores the alternative frequency, and if the RTK correction information received in the fifth background is valid, then switch the reception modes of the communication module 130 and the first or second broadcast reception module 110, as shown in S460.

Furthermore, the RTK correction information receiving device 100 according to one embodiment of the present disclosure is configured to comprise a memory storing a program code that realizes a method for receiving the RTK correction information described with reference to FIG. 7 to FIG. 10, and a processor configured to load and execute the program code stored in the memory.

As described above, the method and device according to the present disclosure have effects of enabling efficient reception of RTK correction information through heterogeneous networks, thereby allowing precise real-time positioning of a rover.

Furthermore, while the preferred embodiments of the present disclosure have been described above, the technical concept of the present disclosure is not limited thereto, and each component of the present disclosure may be modified or amended within the scope of the present disclosure to achieve the same purpose and effect.

Additionally, while preferred embodiments of the present disclosure have been described and illustrated above, the present disclosure is not limited to the described specific embodiments and those skilled in the art will appreciate that various modifications and variations can be made within the scope of the claims without departing from the essence of the present disclosure. Therefore, the technical protection scope of the present disclosure should be determined by the following claims.

What is claimed is:

1. A method for receiving real-time kinematic (RTK) correction information in a device for receiving the RTK correction information through heterogeneous networks, the method comprises:
receiving RTK correction information in a first foreground through a broadcast network at a specific frequency in a first broadcast reception module;
based on the RTK correction information received in the first foreground being predicted to be invalid within a predetermined cycle, receiving RTK correction information in a first background through a communication network in a communication module; and
based on the RTK correction information received in the first foreground being determined to be invalid, switching a reception mode of the first broadcast reception module to background and a reception mode of the communication module to foreground.

2. The method of claim 1, wherein the method further comprises:
based on an alternative frequency capable of receiving the RTK correction information being explored in the first broadcast reception module and the alternative frequency being determined to be valid, blocking the communication module from receiving the RTK correction information, switching the reception mode of the first broadcast reception module to foreground, and switching the reception mode of the communication module to background.

3. The method of claim 1, wherein an error rate of the received RTK correction information is calculated, then if the error rate continuously increases during a predetermined cycle, the error rate is predicted to exceed a predetermined threshold within the predetermined cycle based on an increasing rate of the error rate, and the error rate exceeds the predetermined threshold, then the received RTK correction information is determined to be invalid.

4. The method of claim 2, the method further comprises:
exploring an alternative frequency capable of receiving RTK correction information from a broadcast frequency list in the first broadcast reception module;
receiving RTK correction information in a second background through the broadcast network at the alternative frequency explored in the first broadcast reception module; and
based on the RTK correction information received in the second background through the alternative frequency of the broadcast network by the first broadcast reception module being determined to be valid, blocking the reception of RTK correction information of the communication module, switching the reception mode of the communication module to background and switching the reception mode of the first broadcast reception module to foreground,
wherein the alternative frequency is stored and managed in the broadcast frequency list according to each of regions and periodically updated through the broadcast network.

5. The method of claim 1, further comprise:
based on the RTK correction information not being received in the first foreground, switching the reception mode of the communication module to foreground and switching the reception mode of the first broadcast reception module to background;
exploring an alternative frequency capable of receiving RTK correction information from a broadcast frequency list in the first broadcast reception module;
receiving RTK correction information in third background through the broadcast network at the alternative frequency explored in the first broadcast reception module; and
based on the RTK correction information received in the third background being determined to be valid, switching the reception mode of the first broadcast reception module to foreground, blocking the reception of RTK correction information through the communication module, and switching the reception mode of the communication module to background.

6. The method of claim 1, further comprise:
based on the RTK correction information received in the first foreground being predicted to be invalid within predetermined cycle, exploring of an alternative frequency capable of receiving RTK correction information by referring to a broadcast frequency list in a second broadcast reception module;
receiving the RTK correction information in fourth background through the broadcast network at the alternative frequency explored in the second broadcast reception module; and
based on the RTK correction information received in the first foreground being invalid, switching the reception mode of the second broadcast reception module or the communication module to foreground, and switching the reception mode of the first broadcast reception module to background, depending on validity of the RTK correction information received in the first background and the fourth background respectively.

7. The method of claim 6, further comprises:
based on the RTK correction information received both in the first background and the fourth background respectively being valid, blocking the reception of RTK correction information through the communication module, switching the reception mode of the second broadcast reception module to foreground, blocking the RTK correction information reception through the first broadcast reception module, and switching the reception mode of the first broadcast reception module to the background.

8. The method of claim 6, further comprises:
based on the RTK correction information received in the first background being valid and the RTK correction information received in the fourth background being invalid, switching the reception mode of the communication module to foreground, blocking the RTK correction information reception from the first broadcast reception module and the second broadcast reception module, and switching the reception mode of the first broadcast reception module to background,
based on an alternative frequency capable of receiving RTK correction information being explored in the first broadcast reception module or the second broadcast reception module, and the alternative frequency being determined to be valid, blocking the RTK correction information reception for the communication module, switching the reception mode of the communication module to background, and switching the reception mode of the first broadcast reception module or the second broadcast reception module having explored the alternative frequency to foreground.

9. The method of claim 6, further comprises:
based on the RTK correction information not being received in the first foreground, switching the reception mode of the communication module to foreground, and switching the reception mode of the first broadcast reception module to background,
based on an alternative frequency capable of receiving RTK correction information in the first broadcast reception module or the second broadcast reception module being explored and the alternative frequency being determined to be valid, blocking the reception of the RTK correction information from the communication module, switching the reception mode of the communication module to background, and switching the reception mode of the first broadcast reception module or the second broadcast reception module having explored the alternative frequency to foreground.

10. A device for receiving the RTK correction information through heterogeneous networks, the device comprises:
a memory configured to store a program code implementing the RTK correction information reception method of claim 1 through the heterogeneous networks; and
a processor configured to load the program code stored in the memory and execute the program code.
